(19) United States
(12) Patent Application Publication
(10) Pub. No.: US 2022/0200054 A1
(43) Pub. Date: Jun. 23, 2022

(54) EX SITU ELECTROLYTE ADDITIVES FOR BATTERIES

(71) Applicant: PHILLILPS 66 COMPANY, Houston, TX (US)

(72) Inventors: Zhenhua Mao, Bartlesville, OK (US); Christopher J. LaFrancois, Bartlesville, OK (US); Mengxi Yang, Owasso, OK (US)

(73) Assignee: PHILLIPS 66 COMPANY, HOUSTON, TX (US)

(21) Appl. No.: 17/552,525

(22) Filed: Dec. 16, 2021

Related U.S. Application Data
(60) Provisional application No. 63/127,344, filed on Dec. 18, 2020.
(60) Provisional application No. 63/127,356, filed on Dec. 18, 2020.

(51) Int. Cl. H01M 10/0569; H01M 10/0568

(52) U.S. Cl. CPC H01M 10/0569; H01M 2300/0028; H01M 10/0568

(57) ABSTRACT

A method of reacting a M and a XOZ additive to form a primary solution. This primary solution is then incorporated into an electrolyte to form a precursor liquid electrolyte interphase, wherein the ratio of the XOZ additive to the electrolyte is greater than 0.5% by mass content. In this method, M can be selected from the group consisting of a reducing metal, a reducing metal salt, or combinations thereof. X can be selected from a group 13, 14, 15, or 16 element and Z can be selected from a group 17 element.

### CROSS-REFERENCE TO RELATED APPLICATIONS

This application is a non-provisional application which claims the benefit of and priority to U.S. Provisional Application Ser. No. 63/127,344 filed Dec. 18, 2020 and U.S. Provisional Application Ser. No. 63/127,356 filed Dec. 18, 2020, entitled “Electrolyte Additives for Lithium Ion Batteries” both of which are hereby incorporated by reference in its entirety.

### STATEMENT REGARDING FEDERALLY SPONSORED RESEARCH OR DEVELOPMENT

None.

### FIELD OF THE INVENTION

This invention relates to electric batteries and especially related to electrolytes that enable ion conveyance back and forth between a cathode and anode in a battery.

### BACKGROUND OF THE INVENTION

Rechargeable electric batteries are ubiquitous in our modern lives powering everything from space satellites to cell phones, power tools and electric vehicles. Higher density power storage and longer useful life for such batteries will always be desired. Battery technology has powered a step change improvement in both high availability power and power density seen as light weight for such powerful batteries. Prior to lithium ion batteries, the batteries for electric vehicles were large and heavy such that most developmental electric vehicles were also large and heavy to carry such batteries, such as buses. Now, electric vehicles are the size of conventional cars, are sporty and stylish with impressive acceleration.

One of the challenges for battery technology for electric vehicle use is to make these battery packs last through many cycles of use and recharging. Typically, batteries slowly lose their storage capacity through successive cycles such that an older battery pack provides the owner of the vehicle with less range then when the pack was new. Much effort has been put into developing improved battery technology to increase the initial storage capacity and to extend the life of batteries.

One area of decay in batteries is related to the anode material such as those comprising graphitic structures where lithium ions are intercalated between the graphite crystal lattices during a charging cycle of a battery. While charging, the liquid electrolyte undertakes side reactions that break the edges of the graphite crystal lattices that have a sheet like structure. Even though the electrolyte serves as the lithium ion-conducting conduit between the cathode and the anode, the organic compounds tend to be thermodynamically unstable at the electrode potential when the lithium ions are electrochemically reduced at the graphite anode surface. It is the surface where the lithium ions are inserted or intercalated into the graphite crystal lattices. The thermodynamically unstable organic compounds undertake a variety of undesirable side reactions that precede the reversible lithium insertion into the graphite lattice and regular or pristine graphite powders tend to be catalytic for these undesirable side reactions. For example, solvents such as ethylene carbonate and propylene carbonate can decompose by reduction at the potential below 0.7 volt to form solid and gaseous species such as Li₂CO₃, CO, H₂, etc. Some of the reduced solvent species may themselves insert into graphite lattices resulting in exfoliation of the graphite structure. Such graphite lattice destruction can reduce lithium storage size and therefore the battery storage capacity. And there are additional electrochemical reactions occurring on and in the graphite bulk such as formation of lithium carbides on the first charging that are harmful to the graphite lattice structure.

To protect against these side reactions and the resulting physical damage to the anode materials several processing technologies have been developed.

Much of that electrolyte research has been focused on forming solid electrolyte interface (SEI) layers on the graphite anode particles during the initial charging cycle under the guiding principle that such SEI films prevent solvent and salt from decomposing and inserting into the graphite lattices. But such SEI films present some undesirable side effects including increased interface resistance for the lithium ions, higher expense for the reversible lithium forming the SEI film, lowered power capability, and still having poor cycle life. For example, as shown in WO2018040763 the patent application forms a stable SEI film on the electrode surface of a lithium-ion battery through use of a PO₄R, wherein the R is selected from substituted or unsubstituted C1-C12 alkyl, substituted or unsubstituted C6-C26 aryl, substituted or unsubstituted C5-C22 aryl, and the substituent is halogen. However, such WO2018040763 can only form a SEI when added in amounts from 0.2% to 0.5% mass content. If the content of the additive is too high, a too thick SEI film is easily formed on the surface of the electrode of the battery, so that the impedance of the SEI film is increased.

There exists a need for a low cost means to prevent side reactions on the graphite lattice and consequent lattice destruction that would be desirable for batteries.

### BRIEF SUMMARY OF THE DISCLOSURE

A method of reacting a M and a XOZ additive to form a primary solution. This primary solution is then incorporated into an electrolyte to form a liquid electrolyte interphase layer, wherein the ratio of the XOZ additive to the electrolyte is greater than 0.5% by mass content. In this method, M can be selected from the group consisting of a reducing metal, a reducing metal salt, or combinations thereof. X can be selected from a group 13, 14, 15, or 16 element and Z can be selected from a group 17 element.

An alternate method of reacting a M, a XOZ additive, and a solvent to form a primary solution. This primary solution is then incorporated into an electrolyte to form a precursor liquid electrolyte interphase, wherein the ratio of the XOZ additive to the electrolyte is greater than 1% by mass content. The precursor liquid electrolyte interphase is then incorporated onto a carbon material to form a liquid electrolyte interphase layer. In this method, M can be selected from the group consisting of a lithium metal, a lithium salt, a sodium metal, a sodium salt, a lead metal, a lead salt, a nickel metal, a nickel salt, a cadmium metal, a cadmium salt, a zinc metal, a zinc salt, a vanadium metal, a vanadium salt, a silver metal, a silver salt, or combinations thereof. X can be selected from nitrogen, phosphorus, and sulfur. Z can be selected from the group consisting of fluoride and chloride. Additionally, in this method the solvent is a linear solvent and the XOZ additive is able to reduce the electrochemical reduction of the electrolyte in a battery by an amount greater than 0.5%.

### BRIEF DESCRIPTION OF THE DRAWINGS

A more complete understanding of the present invention and benefits thereof may be acquired by referring to the following descriptions taken in conjunction with the accompanying drawings in which:

FIG. 1 is a schematic diagram showing the basic arrangement of a battery cell.

FIG. 2 is a diagram showing an enlarged cross-sectional view of a graphitic particle having sheet-like layers of crystalline graphite therein and a thin coating along the peripheral surface defining an interface between the graphitic particle and the electrolyte liquid.

FIG. 3 is a chart showing a comparison of the cell voltage profiles on the first cycle for cells with and without resting prior to the first charge on the cell.

FIG. 4 is a chart showing discharge capacity and coulombic efficiency for cells over several cycles where one cell rested overnight prior to the first charge while the other was given its first charge directly after assembly.

FIG. 5 is a chart showing cell resistance for cells over several cycles where one cell rested overnight prior to the first charge while the other was given its first charge directly after assembly.

FIG. 6a is a chart showing coulombic efficiencies and discharge capacities for cells having different POCl₃ concentrations in the electrolyte.

FIG. 6b is a chart showing coulombic efficiencies and discharge capacities for cells having different POCl₃ concentrations in the electrolyte.

FIG. 7 is a chart showing discharge capacities and coulombic efficiencies for cells having varying POCl₃ concentrations.

FIG. 8 is a chart showing cell resistances for cells having different POCl₃ concentrations in the electrolyte.

FIG. 9 is a chart showing discharge capacities and coulombic efficiencies over multiple cycles cells rested and with anode particles pretreated with varying POCl₃ concentrations.

FIG. 10 is a chart showing cell resistances over multiple cycles for cells rested and with anode particles pretreated with different POCl₃ concentrations.

FIG. 11 is a chart showing a comparison of the capacities and coulombic efficiencies as functions of cycle number for the cells with the POCl₃-containing, LiBOB-containing, and PMS-containing electrolytes that were each pre-reacted with lithium.

FIG. 12 is a conceptual image showing the graphitic anode particle in the environment with solvent, anion and lithium cations and the additive prior to first charging the battery cell.

FIG. 13 is a conceptual images showing the graphitic anode particle in the environment with solvent, anion and lithium cations and the additive beginning to lay down a coating over the surface of the graphitic anode particle during charging the battery cell.

FIG. 14 is a conceptual image showing the graphitic anode particle in the environment with solvent, anion and lithium cations and the additive having formed a continuous coating over the surface of the graphitic anode particle from charging the battery cell.

### DETAILED DESCRIPTION

Turning now to the detailed description of the preferred arrangement or arrangements of the present invention, it should be understood that the inventive features and concepts may be manifested in other arrangements and that the scope of the invention is not limited to the embodiments described or illustrated. The scope of the invention is intended only to be limited by the scope of the claims that follow.

As described above, creating a solid electrolyte interface film over the anode materials to protect the same from structural degradation during the charging cycle, one problem continues to be present and that is the integrity of the film. In the present embodiment, a liquid electrolyte interface or a film is formed, which can be broadly described as a stable, a pliable, or a flexible film that is formed over the surface or surfaces of the anode materials. In alternate embodiments the liquid electrolyte interface is formed directly over the SEI. In some embodiments, stable, pliable or flexible film does not fracture or chip. Such a film may also dissipate or diminish on the discharge cycle and reform upon each successive recharge cycle meaning that if the anode has undertaken some kind of physical change, the protective film undertakes the altered shape. This could be seen as a dynamic film or self-healing film comprising a film-forming interface composition.

The current embodiment describes an in-situ method of reacting a M, a XOZ additive and an electrolyte to form a liquid electrolyte interphase layer. In this embodiment, M can be any conventionally known metal or metal salt, more specifically, selected from the group consisting of a reducing metal, a reducing metal salt, or combinations thereof. X can be selected from a group 13, 14, 15, or 16 element. Z can be selected from a group 17 element. Additionally, the ratio of the XOZ additive to the electrolyte can be greater than 0.5% by mass content.

In yet another embodiment, can be envisioned where a M, a XOZ additive, a solvent, and an electrolyte to form a liquid electrolyte interphase layer. In this method M can be selected from the group consisting of: a lithium metal, a lithium salt, a sodium metal, a sodium salt, a lead metal, a lead salt, a nickel metal, a nickel salt, a cadmium metal, a cadmium salt, a zinc metal, a zinc salt, a vanadium metal, a vanadium salt, a silver metal, a silver salt, potassium metal, potassium salt, calcium metal, calcium salt, and magnesium metal, magnesium salt, or combinations thereof. X can be selected from a group consisting of: nitrogen, phosphorus, and sulfur while Z can be selected from the group consisting of fluoride and chloride. Additionally, in this method, the solvent can be a carbonate and the ratio of the XOZ additive to the electrolyte is greater than 1% by mass content. Finally, in this method, the XOZ additive is able to reduce the electrochemical reduction of the electrolyte in a battery by an amount greater than 0.5%.

An alternate method is envisioned of reacting a M and a XOZ additive to form a primary solution. This primary solution is then incorporated into an electrolyte to form a precursor liquid electrolyte interphase, wherein the ratio of the XOZ additive to the electrolyte is greater than 0.5% by mass content. In this method, M can be selected from the group consisting of a reducing metal, a reducing metal salt, or combinations thereof. X can be selected from a group 13, 14, 15, or 16 element and Z can be selected from a group 17 element.

Yet another alternate method is envisioned of reacting a M, a XOZ additive, and a solvent to form a primary solution. This primary solution is then incorporated into an electrolyte to form a precursor liquid electrolyte interphase, wherein the ratio of the XOZ additive to the electrolyte is greater than 1% by mass content. The precursor liquid electrolyte interphase is then incorporated onto a carbon material to form a liquid electrolyte interphase layer. In this method, M can be selected from the group consisting of a lithium metal, a lithium salt, a sodium metal, a sodium salt, a lead metal, a lead salt, a nickel metal, a nickel salt, a cadmium metal, a cadmium salt, a zinc metal, a zinc salt, a vanadium metal, a vanadium salt, a silver metal, a silver salt, or combinations thereof. X can be selected from nitrogen, phosphorus, and sulfur. Z can be selected from the group consisting of fluoride and chloride. Additionally, in this method the solvent is a linear solvent and the XOZ additive is able to reduce the electrochemical reduction of the electrolyte in a battery by an amount greater than 0.5%. It is theorized that the liquid electrolyte interphase layer is formed upon charging.

In yet another embodiment, can be envisioned where a M and a XOZ additive are reacted to form a primary solution. The primary solution is then incorporated into an electrolyte to form a liquid electrolyte interphase layer, wherein the ratio of the XOZ additive in the liquid electrolyte interphase layer can be greater than 0.5% by mass content to the electrolyte. In other embodiments, the electrolyte interphase layer can be greater than 0.6% by mass content to the electrolyte, or even 0.7%, 0.8%, 0.9%, 1.0%, 1.25%, 1.5%, 1.75%, 2%, 3%, 4%, even 5%. In this embodiment, M can be any conventionally known metal or metal salt, more specifically, selected from the group consisting of a reducing metal, a reducing metal salt, or combinations thereof. X can be selected from a group 13, 14, 15, or 16 element. Z can be selected from a group 17 element.

In one embodiment, it is theorized that the liquid electrolyte interphase layer can form a protective film on anode materials present in batteries. In some embodiments, the anode materials are graphitic anode materials. In other embodiments, the protective film is formed on the solid electrolyte interface of the anode materials.

In one embodiment, the reacting of M and the XOZ additive or the M, the XOZ additive and the electrolyte can be done without mixing or stirring and be simply done by pouring all the reagents into a reaction vessel. In one embodiment, M can be selected from the group consisting of: a lithium metal, a lithium salt, a sodium metal, a sodium salt, a lead metal, a lead salt, a nickel metal, a nickel salt, a cadmium metal, a cadmium salt, a zinc metal, a zinc salt, a vanadium metal, a vanadium salt, a silver metal, a silver salt, potassium metal, potassium salt, calcium metal, calcium salt, and magnesium metal, magnesium salt or combinations thereof. In another embodiment, X can be selected from the group consisting of: nitrogen, phosphorus, and sulfur. In the yet another embodiment, Z can be selected from the group consisting of fluoride and chloride.

In non-limiting embodiments, examples of the XOZ additive can be POCl₃, PDX₃, NOX₃, AsOX₃, SbOX₃, BiOX₃, SOX₂, SeOX₂, and BiOX₂, where X═F, Cl, Br, I).

In yet another embodiment, a solvent is reacted with M, the XOZ additive, and the electrolyte. In one embodiment, the solvent is a linear carbonate such as diethyl carbonate. In some embodiments, the linear carbonate solvent comprises

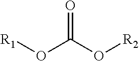

wherein R₁ and R₂ are independently selected from branched or unbranched, substituted or unsubstituted C2 to C12.

In other embodiments, the method involves reacting a M, a XOZ additive, a solvent, and an electrolyte to form a liquid electrolyte interphase layer. In this embodiment, M is selected from the group consisting of: a lithium metal, a lithium salt, a sodium metal, a sodium salt, a lead metal, a lead salt, a nickel metal, a nickel salt, a cadmium metal, a cadmium salt, a zinc metal, a zinc salt, a vanadium metal, a vanadium salt, a silver metal, a silver salt, or combinations thereof. X is selected from a group consisting of: nitrogen, phosphorus, and sulfur. Z is selected from the group consisting of fluoride and chloride. The solvent is a linear solvent. The ratio of the XOZ additive to the electrolyte is greater than 1% by mass content and the XOZ additive is able to reduce the electrochemical reduction of the electrolyte in a battery by an amount greater than 0.5%.

In yet another embodiment, method involves reacting a M, a XOZ additive, and a solvent a primary solution. The primary solution is then incorporated to an electrolyte to form a liquid electrolyte interphase layer, wherein the ratio of the XOZ additive in the liquid electrolyte interphase layer is greater than 0.5% by mass content to the electrolyte. This is followed by incorporating the liquid electrolyte interphase layer onto a carbon material. In this embodiment, M is selected from the group consisting of: a lithium metal, a lithium salt, a sodium metal, a sodium salt, a lead metal, a lead salt, a nickel metal, a nickel salt, a cadmium metal, a cadmium salt, a zinc metal, a zinc salt, a vanadium metal, a vanadium salt, a silver metal, a silver salt, or combinations thereof. X is selected from a group consisting of: nitrogen, phosphorus, and sulfur. Z is selected from the group consisting of fluoride and chloride. The solvent is a linear solvent. The ratio of the XOZ additive to the electrolyte is greater than 1% by mass content and the XOZ additive is able to reduce the electrochemical reduction of the electrolyte in a battery by an amount greater than 0.5%. In this embodiment, the carbon material can be any carbon material used for a battery.

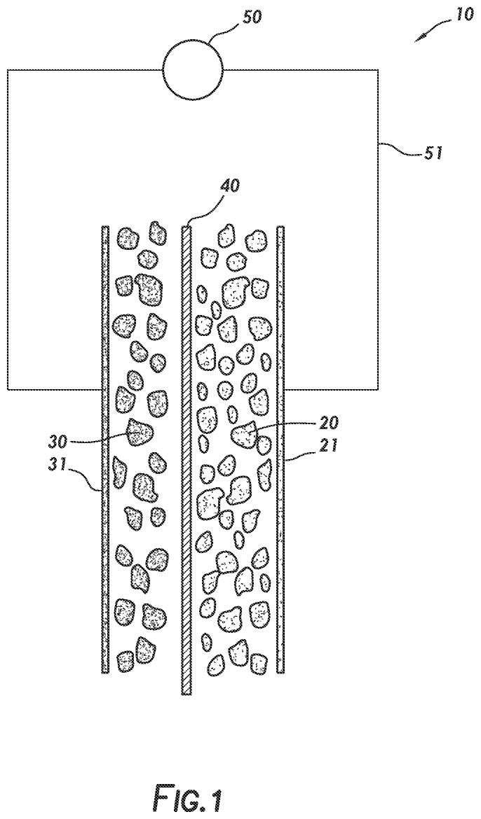

To best understand the present embodiment, a schematic battery is indicated by arrow 10 in FIG. 1. The battery includes multiple particles of cathode material 20 along one side of the battery and multiple particles of anode material 30 on the opposite side thereof. A liquid electrolyte fills the space 40 between the anode and cathode typically with a porous physical separator. Each of the particles of cathode 20 and anode 30 are held in an electrically conductive paste (not specifically shown) that provides electrical conductivity between the particles of anode and cathode to their respective metal electrodes. The liquid electrolyte is arranged to convey lithium ions back and forth between the anode and cathode. An electric load, indicated 50, such as a light or electric motor may be attached to the battery 10 with wiring shown at 51. When battery 10 is charged, positive ions form at the cathode particles 20 and cross through the electrolyte and intercalated into the anode particles 30.

Turning now to getting work out of the battery, owing to the electro-chemical natures of the cathode and anode materials, the positive ions are urged (attracted and repelled, respectively) to move from the anode 30 through the electrolyte and back to the cathode 20 and thereby urging electrons through the circuit 51 and the load 50. The amount of ions and electrons are substantially in balance on either side of the battery due to the inherent repulsion of like charges. In other words, if the circuit is broken, such as by a switch in the off position, once the positively charged ions have moved to the cathode and the cathode side begins to undertake a positive charge, the progression of additional ions stops repelled by the positive charge. Once electrons are allowed to pass through the circuit 51 to the cathode terminal, the internal electro-chemical process picks back and further lithium ions move from anode to cathode. The process of passing the electrons through the load causes electrical work to be accomplished such as illuminating a light bulb or turning an electric motor.

For lithium-ion batteries, the cathode is generally formed of a lithium bearing chemical structure that forms lithium ions during charging of the battery that transit through the electrolyte and across the separator 40 and intercalate into the anode 30. Anode materials are less chemically complex and high performing anode materials may densely store the lithium ions in a manner where they are easily liberated fully back to the cathode without permanent bonding into the anode. In one embodiment, the method can be used in batteries like those shown in FIG. 1. It is anticipated that this method can be used for any conventionally known or anticipated battery that has a metal ion such as lithium ion batteries, sodium batteries, lead batteries, nickel batteries, cadmium batteries, zinc batteries, vanadium batteries, even silver batteries.

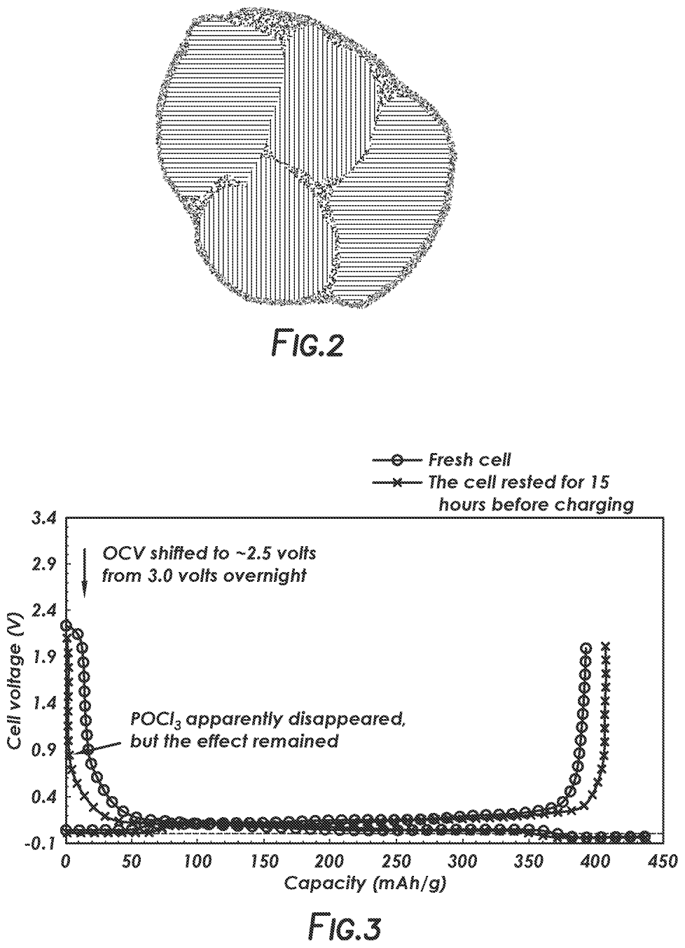

Turning now to FIG. 2, a single particle of the anode 30 is shown. Each particle is typically very small being about a micron in average cross-section up to about 30 microns although larger and smaller sizes may work. The particles include crystalline graphite lattices within as seen by the regions of parallel lines sometimes described as sheets or graphite sheets. The spacing between the graphite lattices in the crystalline structure is well suited for accommodating lithium ions. Unfortunately, at the exposed ends of the graphite sheets, as the lithium carried by the electrolyte is to be reduced for intercalation, side reactions at low voltage potentials are catalyzed producing solid and gaseous species such as Li₂CO₃, Li₂O, CO, CH₄, H₂ and others. Some of these species insert themselves into the lattices breaking or exfoliating the sheet like structures. The consequent loss of a small amount of lattice structure accumulates over time effectively reducing the anode storage capacity. As seen in FIG. 2, the anode particle can be covered with a protective layer 35 substantially preventing the catalytic reaction at the ends of the sheet-like lattice structure. This protective layer is also referred to as the liquid electrolyte interface or protective film as mentioned above.

In one embodiment, the protective layer 35 can be a liquid solution or liquid electrolyte interface that adheres to the surfaces of the anode particles 30 and allows the lithium ions to pass through the liquid coating but prevents or hinders the reactions and attempted insertion of non-lithium ions. The liquid protective layer 35 is can be formed in-situ or ex-situ in the fully completed battery or cell. In practice, there may be many ways to create and maintain the liquid protective layer 35 including the creation of an electrolyte mixture characterized as having LiPF₆ mixed with a solvent mixture including linear carbonate solvents, propylene carbonate, and an ethylene carbonate. In a non-limiting embodiment, linear carbonate solvents can include dimethyl carbonate, diethyl carbonate, ethyl methyl carbonate. An alternative method includes adding carbon black with LiBV₂(C₂O₄), POCl₃, and SOCl2.

Electrolyte additives in one embodiment are chemical compounds and their mixtures that consist of at least one of these elements: nitrogen, phosphorus, sulfur, oxygen, and halogen element such as fluoride and chloride. Such electrolyte additives can be either liquid or solid that are soluble in typical electrolyte systems for lithium-ion batteries and are electrochemically active at an electrode potential of higher than 0.8 volts versus the metal ion. The term “electrochemical active” implies that the additive may be electrochemically reduced to solid metal salts on the surface of the anode particles at a desirable electrode potential. In addition, the resulting metal salts can be metal ion conductive so that metal ions can cross the liquid protective film. The amount of the electrolyte additives can be between 100 ppm and 5% by volume. The electrical charge due to the electrochemical reduction of the electrolyte additive is preferably between 0.5% and 15% of the total capacity of anode material in the cell. The electrolyte additives are preferably completely dissolved in the electrolyte at a concentration. The liquid electrolyte additives are completely miscible. Gaseous and solid additives can be sufficiently soluble in the electrolyte to be added.

The liquid compounds include those that contain one or two of these positive valence elements: nitrogen, sulfur, and phosphorus such as N5+, S4+, and P5+. The examples include N₂O₄, PBr₃, SOCl₂, PSCl₂ and POCl₃. The solid additives include organic and inorganic compounds such as elemental sulfur, lithium polysulfide salts, and lithium nitrate. The gaseous additives are soluble to a certain degree, the examples include sulfur oxides such as SO₂ and SO₃.

The amount of the electrolyte additive is between 100 ppm and 5% by volume, the electrical charge due to the electrochemical reduction of the electrolyte additive is between 0.5% and 15% of the total capacity of graphite anode material in the cell.

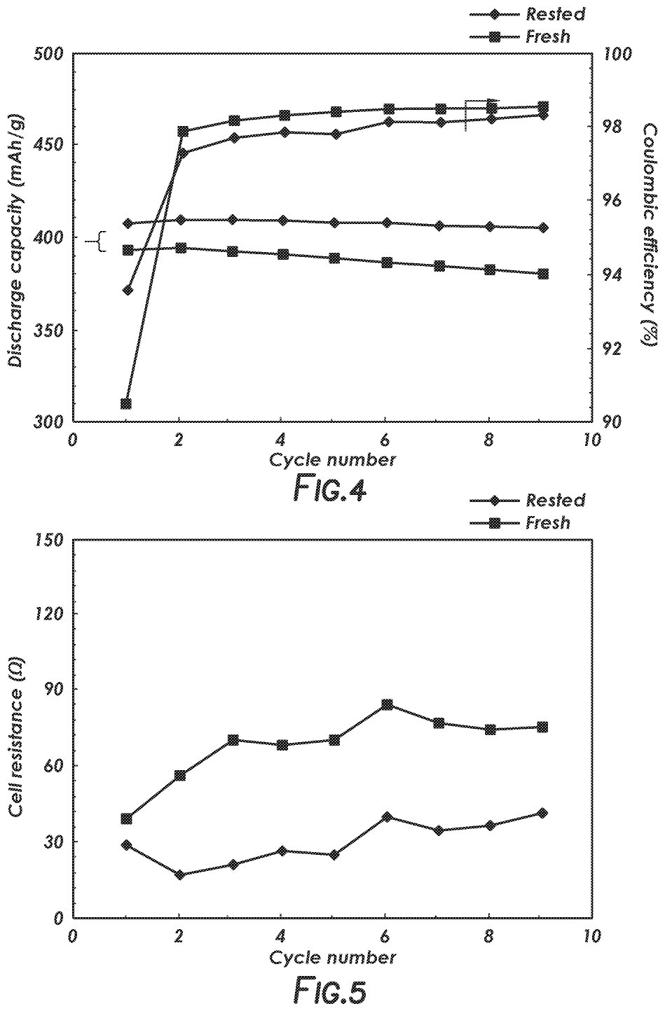

Turning to examples, FIG. 3 shows a comparison of the cell voltage profiles on the first cycle for the cells with and without resting prior to the first charge on the cell. There are two significant differences between the two sets of curves. One is that the open-circuit voltage shifted from about 3.0 volts to 2.5 volts and the POCl₃ reduction plateau had diminished for the cells that rested overnight before the test and before the first charge. In addition, these rested cells exhibited higher initial coulombic efficiency and discharge capacity as well as lower resistance than those without resting as seen in FIGS. 4 and 5.

The shift in the open-circuit voltage and the absence of a POCl₃ reduction plateau indicates that POCl₃ is reactive with Li metal in the cells and has been consumed by a reaction during resting. In addition, high capacity resulted from the low resistance as seen in FIG. 5. The high initial coulombic efficiency is theorized to be due to the absence of irreversible capacity loss caused by POCl₃ reduction. The data depicts that there are some of the resulting reaction species from POCl₃ reaction with Li are soluble in the electrolyte and these species are not electrochemically reactive at a potential below 2.5 volts versus Li and the generated species migrate to the graphite electrode and form a protective film on surfaces of the graphite particles at the potential below 1.0 volts versus Li. It is theorized that the protective film minimizes any other side reactions from occurring such as solvent decomposition that cause graphite destruction. It may be further inferred that the increase in the initial coulombic efficiency may be due to the accumulation of the reduced species of the electrolyte additives in the POCl₃ and SOCl₂ cases at the graphite solid/electrolyte interface. These reduced species appear to be oxo phosphoryl bearing compounds that may be termed as a film-forming interface composition.

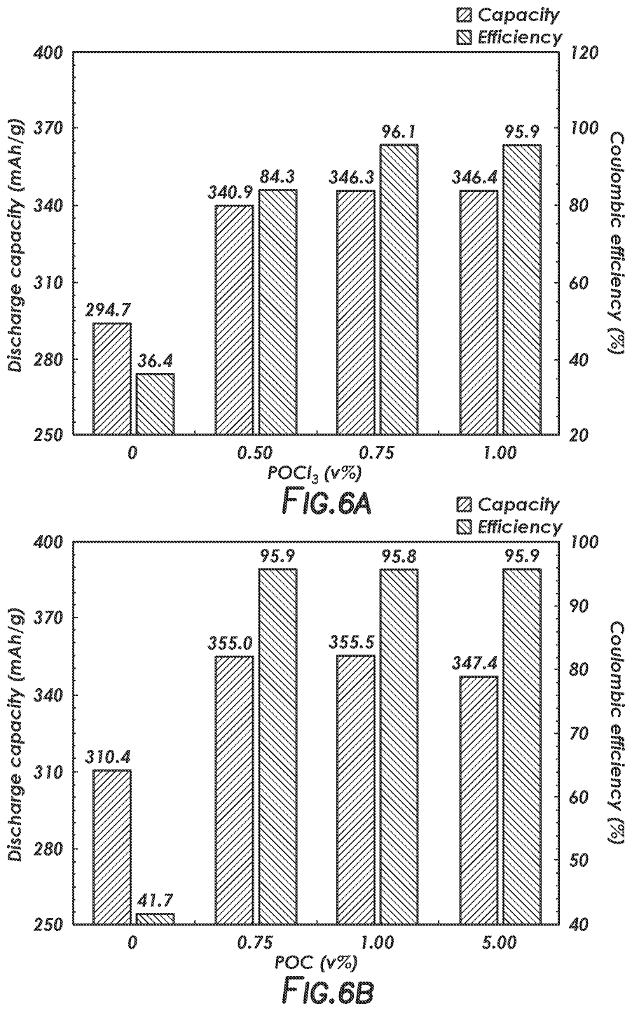

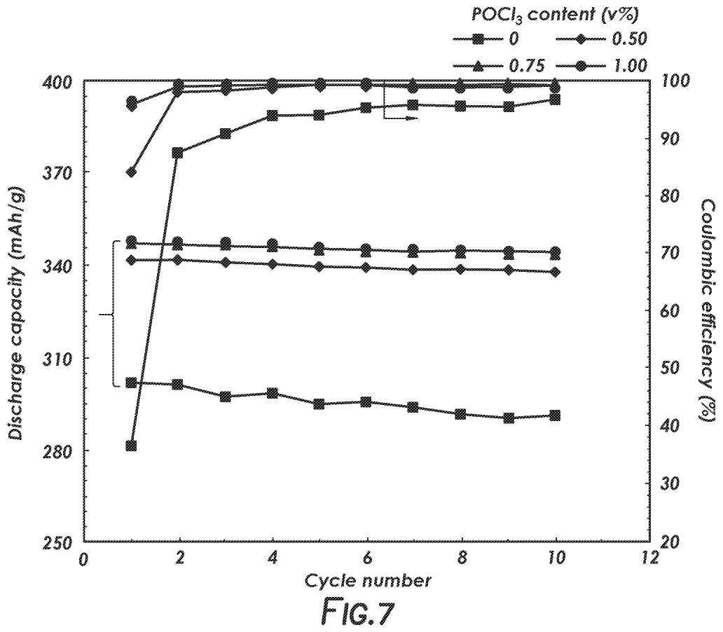

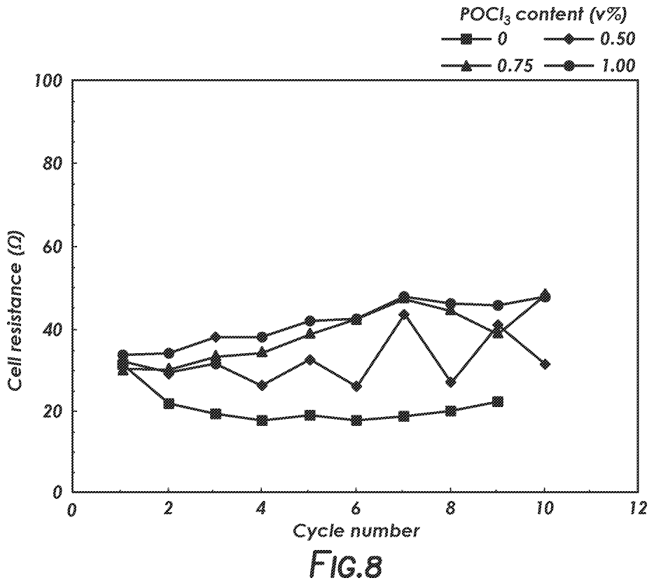

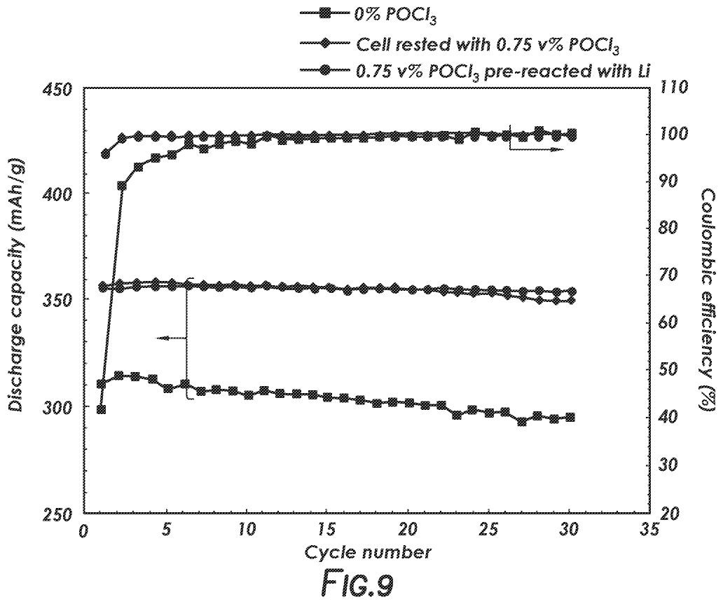

Since this development was first seen in cells after resting, another set of the experiments were conducted with a different graphite powder and different POCl₃ concentrations where cells were rested for 16 hours before tests. FIG. 6a and FIG. 6b shows comparisons of the initial coulombic efficiencies and discharge capacities for different POCl₃ concentrations. In FIG. 6a, the initial coulombic efficiency reached was about 96% as POCl₃ concentration increased to 0.75 v % and stayed the same at 1.0 v %, indicating that the maximum achievable efficiency is about 96%. Please also note that 1 v % generally equals to 1.3 wt % by mass. The discharge capacity follows the same trend with POCl₃ concentration as the coulombic efficiency. FIGS. 7 and 8 show comparison of the capacities, coulombic efficiencies, and cell resistances at different cycle numbers for different POCl₃ concentrations. As compared to cells that were subjected to first charging promptly after assembly, the discharge capacity of the rested cells decreased, and the resistance increased with cycle number. This indicates that full capacity is achieved on the first cycle where the initial charging has built the protection layer at the liquid/solid interface and subsequent cycling has minimal effect on the electrochemical processes where capacity slowly fades.

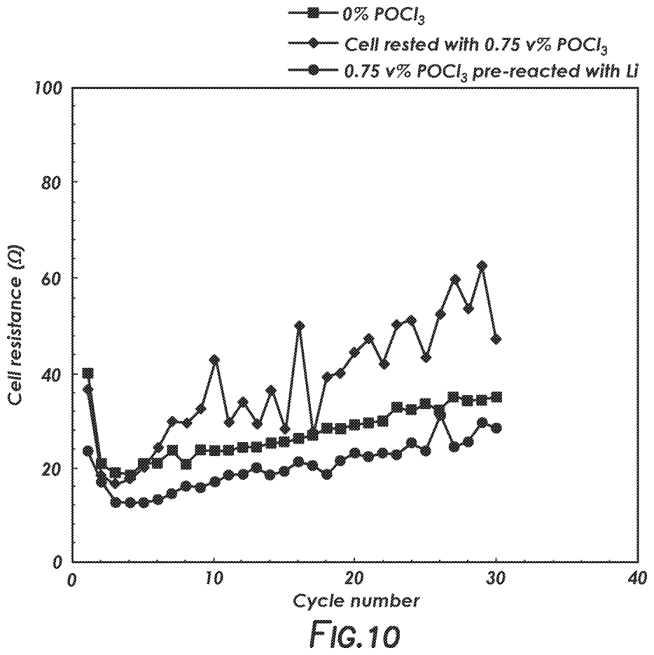

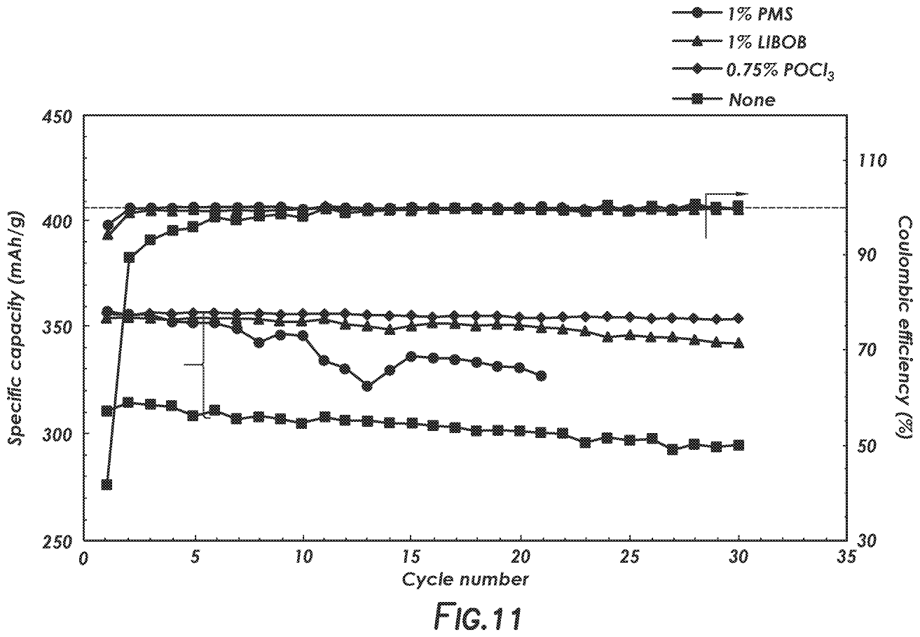

To analyze whether the conditions for creating the liquid protection layer over the graphite anode particles may be attained with a pre-reacted electrolyte (ex-situ to the battery cell) rather than going through a resting step for an assembled cell (in-situ), it is noted that the soluble species from the POCl₃ reduction reaction with lithium in the electrolyte seems to be responsible for achieving the maximum coulombic efficiency and capacity. Because POCl₃ is reducible with lithium, an electrolyte in which POCl₃ is pre-reacted with lithium prior to cell assembly should contain the same species as those in the rested cells and may perform better at protecting the graphite anode particles than batteries where the lithium reaction occurs by resting the cells as there may be residual POCl₃ in the rested cells. Reasons for anticipating better battery performance using pre-reacted film-forming additive POCl₃ with lithium is that the solids are not added to the battery and the pre-reacted solution may be assured to have all or virtually all POCl₃ creating the resulting film-forming interface composition. Thus, any extant solids and POCl₃ that may hinder battery performance are essentially eliminated from the assembled battery. For verifying the rationale that pre-reacting leads to the desired film-forming interface composition, an electrolyte containing 0.75 v % POCl₃ was mixed with lithium in a glass vial for two days. It was observed that during mixing the metal foils turned from light to dark yellow. Some white precipitate appeared in the liquid indicating that the POCl₃ reduction also yields solid particles. The resulting electrolyte was left to settle till the liquid portion became clear. A set of coin cells were assembled with the clear electrolyte and tested right after assembling. The open-circuit voltage was ˜2.5 volts for these cells after the cells were assembled and didn't change with time, indicating that the open-circuit voltage originates from those soluble species from the POCl₃ reduction with lithium metal. FIGS. 9 and 10 shows comparisons of the discharge capacities and coulombic efficiencies FIG. 9 and the cell resistances FIG. 10 for the cells with such pre-reacted electrolyte, rested cells, and cells with the base electrolyte. The coulombic efficiencies overlap with each other and the discharge capacities were very stable with cycle number for the cells with the pre-reacted electrolyte whereas the capacity started to drop gradually after initial cycles for the rested cells. The cells with the pre-reacted electrolytes exhibited the lowest cell resistance among the cells tested FIG. 10.

To show the effect of liquid film protection versus solid-electrolyte interface protection, FIG. 11 compares the capacities and coulombic efficiencies as functions of cycle number for the cells with the POCl₃-containing, LiBOB-containing, and PMS-containing electrolytes that were pre-reacted with Li, respectively. The cells with the pre-reacted POCl₃ electrolyte maintained nearly the same capacity throughout the tested cycles whereas the other cells had fading capacities to different degrees.

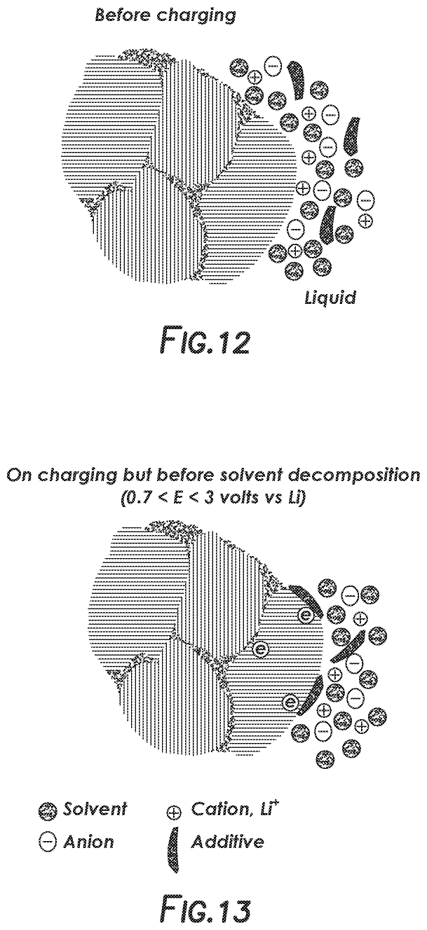

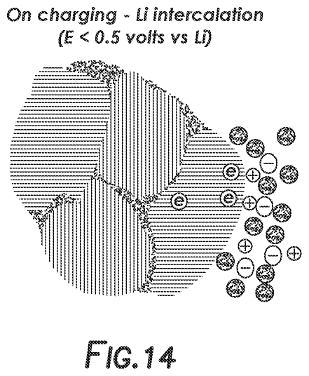

In summarizing the experimental results described above, the effect of the pre-reacted POCl₃ electrolyte (film-forming interface composition) on the performance of pristine graphite electrodes as anode materials can be postulated in the process schematically illustrated in FIGS. 12, 13 and 14. The soluble species resulting from the POCl₃ reduction are electrochemically stable at the potential below 2.0 volts versus Li as seen in FIG. 12. When the graphite electrode is polarized negatively (on charging), these species of film-forming interface composition migrate towards graphite electrode surface and accumulate at the liquid/solid interface FIG. 13 between the liquid electrolyte and the solid surface and then form a continuous layer or film at the interface that quickly becomes continuous at the electrode potential below 1.0 volts versus Li, displacing or effectively squeezing solvent molecules away from the solid/liquid interface. Since a film is Li+ ionic, conductive and stable it is presumptively interpreted as a pliable or flexible film or liquid at the solid/electrolyte interface, the graphite electrode can then be quickly polarized to the region where Li⁺ reduction at the solid surface and intercalation into graphite lattice occur as shown in FIG. 14. Recognizing that such a film is dynamically stretchable and highly Li⁺ conductive, the graphite electrode can be reversibly charged/discharged, yielding the maximum coulombic efficiency and stable capacity on cycling.

The film protecting the graphitic anode particles has pliability or flexibility to allow the particles to swell which would tend to crack solid layers or interfaces. The layer of the current embodiment is self-assembling, or self-forming during charging and is dynamic in that it thins during discharge when the side reactions do not typically occur but builds during recharging. In this aspect, it has been described as self-healing.

In closing, it should be noted that the discussion of any reference is not an admission that it is prior art to the present invention, especially any reference that may have a publication date after the priority date of this application. At the same time, each and every claim below is hereby incorporated into this detailed description or specification as an additional embodiment of the present invention.

Although the systems and processes described herein have been described in detail, it should be understood that various changes, substitutions, and alterations can be made without departing from the spirit and scope of the invention as defined by the following claims. Those skilled in the art may be able to study the preferred embodiments and identify other ways to practice the invention that are not exactly as described herein. It is the intent of the inventors that variations and equivalents of the invention are within the scope of the claims while the description, abstract and drawings are not to be used to limit the scope of the invention. The invention is specifically intended to be as broad as the claims below and their equivalents.

1. A method comprising:
reacting a M and a XOZ additive to form a primary solution; and
incorporating the primary solution to an electrolyte to form a precursor liquid electrolyte interphase, wherein the ratio of the XOZ additive to the electrolyte is greater than 0.5% by mass content,
wherein M is selected from the group consisting of a reducing metal, a reducing metal salt, or combinations thereof;
wherein X is selected from a group 13, 14, 15, or 16 element; and
wherein Z is selected from a group 17 element.

2. The method of claim 1, wherein the liquid electrolyte interphase layer forms a protective film on anode materials.

3. The method of claim 2, wherein the anode materials are graphitic anode materials.

4. The method of claim 2, wherein the protective film is formed on the solid electrolyte interface of the anode materials.

5. The method of claim 1, wherein M is selected from the group consisting of: a lithium metal, a lithium salt, a sodium metal, a sodium salt, a lead metal, a lead salt, a nickel metal, a nickel salt, a cadmium metal, a cadmium salt, a zinc metal, a zinc salt, a vanadium metal, a vanadium salt, a silver metal, a silver salt, potassium metal, potassium salt, calcium metal, calcium salt, and magnesium metal, magnesium salt, or combinations thereof.

6. The method of claim 1, wherein X is selected from the group consisting of: nitrogen, phosphorus, and sulfur.

7. The method of claim 1, wherein Z is selected from the group consisting of fluoride and chloride.

8. The method of claim 1, wherein the XOZ additive is POCl₃.

9. The method of claim 1, wherein the method of reacting the M, the XOZ additive, and the electrolyte does not require stirring or mixing.

10. The method of claim 1, wherein a solvent is reacted with the M, the XOZ additive, and the electrolyte.

11. The method of claim 10, wherein the solvent is a linear carbonate solvent.

12. The method of claim 11, wherein the linear carbonate solvent comprises 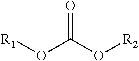
wherein R₁ and R₂ are independently selected from branched or unbranched, substituted or unsubstituted C2 to C12.

13. A method comprising
reacting a M, a XOZ additive, and a solvent to form a primary solution;
incorporating the primary solution to an electrolyte to form a precursor liquid electrolyte interphase, wherein the ratio of the XOZ additive in the precursor liquid electrolyte interphase is greater than 1% by mass content to the electrolyte; and
incorporating the precursor liquid electrolyte interphase onto a carbon material to form a liquid electrolyte interphase layer,
wherein M is selected from the group consisting of: a lithium metal, a lithium salt, a sodium metal, a sodium salt, a lead metal, a lead salt, a nickel metal, a nickel salt, a cadmium metal, a cadmium salt, a zinc metal, a zinc salt, a vanadium metal, a vanadium salt, a silver metal, a silver salt, potassium metal, potassium salt, calcium metal, calcium salt, and magnesium metal, magnesium salt, or combinations thereof;
wherein X is selected from a group consisting of: nitrogen, phosphorus, and sulfur;
wherein Z is selected from the group consisting of fluoride and chloride;
wherein the solvent is a linear solvent; and
wherein the XOZ additive is able to reduce the electrochemical reduction of the electrolyte in a battery by an amount greater than 0.5%.
